(19) United States
(12) Patent Application Publication
(10) Pub. No.: US 2009/0303944 A1
(43) Pub. Date: Dec. 10, 2009

(54) RADIO COMMUNICATION BASE STATION APPARATUS AND RESOURCE BLOCK ALLOCATION METHOD

(75) Inventors: Masaru Fukuoka, Ishikawa (JP); Akihiko Nishio, Kanagawa (JP)

Correspondence Address: Dickinson Wright PLLC;James E. Ledbetter, Esq., International Square, 1875 Eye Street, N.W., Suite 1200, Washington, DC, 20006, US

(73) Assignee: Panasonic Corporation, Osaka (JP)

(21) Appl. No.: 12/306,245

(22) PCT Filed: Jun. 25, 2007
(86) PCT No.: PCT/JP2007/062716

§ 371 Date: Dec. 22, 2008

(30) Foreign Application Priority Data
Jun. 26, 2006 (JP) 2006-175820

(51) Int. Cl. H04W 72/04

(52) U.S. Cl. 370/329

(57) ABSTRACT

A base station can perform distributed allocation enabling a resource block allocation with a higher priority while suppressing a control information amount. In this base station, the localized allocation of data to terminals #5 to #8 is set to a higher priority than distributed allocation of data to terminals #1 to #4 among the terminals #1 to #8. The data to the terminals #5 to #8 are allocated to any of the resource blocks #1 to #8 by frequency scheduling based on line quality of each terminal and each resource block. After this, the remaining resource blocks other than the resource blocks used for allocation to the terminals #5 to #8 with a higher priority are used as distributed resource blocks and the data to the terminals #1 to #4 are allocated in the remaining resource blocks according to the allocation rule common to the terminals #1 to #4.

### TECHNICAL FIELD

The present invention relates to a radio communication base station apparatus and a resource block allocation method.

### BACKGROUND ART

In the field of radio communication, especially in mobile communication, a variety of information such as image and data in addition to speech has become an object of transmission in recent years. The demand for higher-speed transmission is expected to further increase in the future, and, to perform high-speed transmission, a radio transmission technique is required that utilizes limited frequency resources more effectively and achieves high transmission efficiency.

OFDM (Orthogonal Frequency Division Multiplexing) is one of radio transmission techniques to meet this demand. OFDM is one of multicarrier communication techniques, whereby data is transmitted in parallel using a large number of subcarriers, and it is known that OFDM provides high frequency efficiency and low inter-symbol interference under a multipath environment and is effective to improve transmission efficiency.

Studies are being conducted for performing frequency scheduling transmission and frequency diversity transmission using this OFDM on downlink, when a radio communication base station apparatus (hereinafter simply “base station”) frequency division multiplexes data for a plurality of radio communication terminal apparatuses (hereinafter simply “terminal”) on a plurality of subcarriers (see Non-Patent Document 1 for instance).

In frequency scheduling transmission, a base station adaptively allocates subcarriers for terminals, based on the downlink channel quality of each frequency band in each terminal, so that it is possible to obtain a maximal multi-user diversity effect, thereby enabling extremely efficient communication. This frequency scheduling transmission scheme is mainly suitable for data transmissions when a terminal moves at low speed. On the other hand, since frequency scheduling transmission requires feedback of channel quality information from each terminal, frequency scheduling transmission is not suitable for data transmissions when a terminal moves at high speed. Moreover, frequency scheduling transmission is carried out based on downlink channel quality of each terminal, and so it is difficult to apply frequency scheduling transmission to a common channel. Also, frequency scheduling transmission is normally carried out in resource block (“RB”) units, which groups a plurality of consecutive and neighboring subcarriers in a range of coherent bandwidth and therefore does not obtain much frequency diversity effect.

On the other hand, frequency diversity transmission allocates data for the terminals to subcarriers over the entire band in a distributed manner, that is, performs distributed allocation, so that a high frequency diversity effect can be obtained. Moreover, frequency diversity transmission does not require feedback of channel quality information per RB from terminals, so that frequency diversity transmission is a useful scheme when frequency scheduling transmission is difficult to apply, as described above. On the other hand, frequency diversity transmission is carried out regardless of channel quality per RB for terminals, and therefore does not obtain multi-user diversity effect such as provided by frequency scheduling transmission.

As described above, frequency scheduling transmission is carried out per RB, and therefore an RB for carrying out frequency scheduling transmission is referred to as a localized RB (Localized Resource Block: “LRB”). Further, in frequency diversity transmission, data for terminals is allocated to RBs over the entire band, so that an RB for carrying out frequency diversity transmission is referred to as a distributed RB (Distributed Resource Block: “DRB”) (see Non-Patent Document 2, for instance).

Further, recently, studies are conducted for TTI (Transmission Time Interval) concatenation (see Non-Patent Document 3, for instance). Normally, one subframe is one TTI. By contrast with this, TTI concatenation is a technique of concatenating a plurality of subframes and using them as one TTI. For this reason, where TTI concatenation is in use, a base station transmits a control channel signal used in common for a plurality of concatenated subframes only in the first subframe in a plurality of subframes. Consequently, TTI concatenation is an effective technique to reduce the amount of control information. TTI concatenation may be also referred to as “long TTI” or “adaptive TTI.”

### Non-patent Document 1: R1-050604 “Downlink Channelization and Multiplexing for EUTRA” 3GPP TSG RAN WG1 Ad Hoc on LTE, Sophia Antipolis, France, 20-21 Jun., 2005

Non-patent Document 2: 3GPP RAN WG1 #42 meeting (2005.8) R1-050884 “Physical Channel Structure and Procedure for EUTRA Downlink”
Non-patent Document 3: 3 GPP RAN WG1 #41 meeting (2005.3) R1-050464 “Physical Channel Structure for Evolved UTRA”

### DISCLOSURE OF INVENTION

### Problems to be Solved by the Invention

Here, it is possible to use frequency scheduling transmission and frequency diversity transmission at the same time where a relatively broad frequency bandwidth is available. That is, frequency division multiplexing LRBs and DRBs on a plurality of subcarriers in one OFDM symbol is possible. For example, it is possible that, among terminals #1 to #8 the base station communicates at the same time, frequency scheduling transmission is carried out for terminals #5 to #8 and frequency diversity transmission is carried out for terminals #1 to #4. Further, to reduce the overhead of control channel signals for reporting distributed allocation results to terminals, let us discuss below using frequency diversity transmission and TTI concatenation in combination, that is, applying TTI concatenation to distributed allocation.

At this time, to obtain the maximal multi-user diversity effect, it is possible that, on a per subframe basis, first, LRBs are allocated, with priority, for the data for terminals #5 to #8 by frequency scheduling for all RBs, and next, the remaining RBs, as DRBs, other than LRBs, are subject to distributed allocation for data for terminals #1 to #4. That is, it is possible to perform distributed allocation for the remaining RBs other than the RBs used in priority allocation.

However, by this means, DRBs vary every subframe accompanying the changes of LRBs depending on frequency scheduling result, that is, depending on priority allocation results, and, consequently, control channel signals are required on a per subframe basis to report to which subcarriers data for terminals #1 to #4 subject to frequency diversity transmission is distributed-allocated, thereby causing loss of effect of reducing the amount of control information by applying TTI concatenation to distributed allocation.

Although priority allocation to LRBs used in frequency scheduling are described as an example of priority allocations with above explanation, the same problem occurs in other priority allocation. For example, the same problem occurs in a case where a common channel signal is priority-allocated to specific RBs among all RBs once every several subframes.

It is therefore an object of the present invention to provide a base station apparatus and RB allocation method that makes it possible to allocate RBs, with priority, and perform distributed allocation with a reduced amount of control information.

### Means for Solving the Problem

The base station of the present invention used in a radio communication system in which a plurality of subcarriers forming a multicarrier signal are grouped into a plurality of RBs, adopts a configuration including: an allocating section that, in the plurality of RBs, performs a distributed allocation of data for a terminal to remaining RBs other than RBs used in a priority allocation according to an allocation rule shared with the terminal; and a transmitting section that transmits the multicarrier signal including the data.

### ADVANTAGEOUS EFFECT OF THE INVENTION

According to the present invention, it is possible to perform distributed allocation that makes it possible to allocate RBs, with priority, and reduce the amount of control information.

### BRIEF DESCRIPTION OF DRAWINGS

FIG. 1 is a block diagram showing a configuration of the base station, according to Embodiment 1 of the present information;

FIG. 2 is an example of RBs, according to Embodiment 1 of the present invention;

FIG. 3 is an RB allocation example by frequency scheduling, according to Embodiment 1 of the present invention;

FIG. 4 is distributed allocation example 1, according to Embodiment 1 of the present invention;

FIG. 5 is the distributed allocation example (subframes n to n+2), according to Embodiment 1 of the present invention;

FIG. 6 is distributed allocation example 2, according to Embodiment 1 of the present invention;

FIG. 7 is distributed allocation example 3, according to Embodiment 1 of the present invention;

FIG. 8 is distributed allocation example 4, according to Embodiment 1 of the present invention;

FIG. 9 is DVRBs (subframes n to n+2), according to Embodiment 2 of the present invention;

FIG. 10 is the distributed allocation example (subframes n to n+2), according to Embodiment 2 of the present invention;

FIG. 11 is the distributed allocation example (subframes n to n+2), according to Embodiment 3 of the present invention;

FIG. 12 is DVRBs, according to Embodiment 4 of the present invention; and

FIG. 13 is the distributed allocation example, according to Embodiment 4 of the present invention.

### BEST MODE FOR CARRYING OUT THE INVENTION

Now, embodiments of the present invention will be described in detail with reference to the accompanying drawings. In the following embodiments, although priority allocation to LRBs used in frequency scheduling will be explained as an example of priority allocation, the priority allocation in the present invention is not limited to this. For example, the present invention can be utilized in a case where a common channel signal is priority-allocated to specific RBs among all RBs once every several subframes.

### Embodiment 1

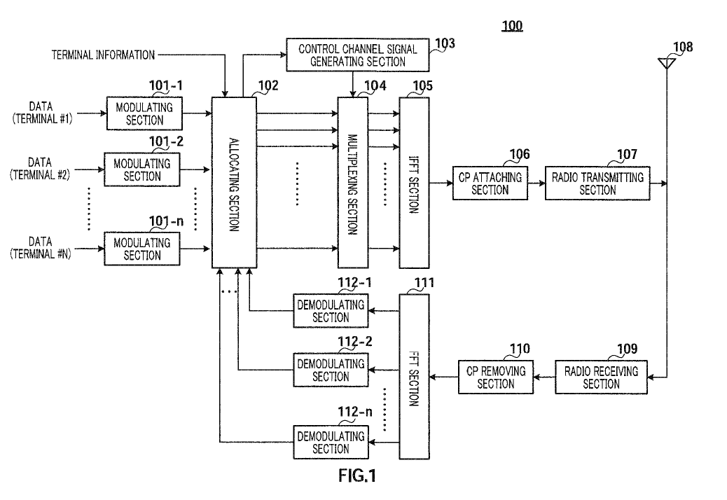

FIG. 1 shows the configuration of base station 100 according to the present embodiment. Base station 100 frequency division multiplexes data for a plurality of terminals #1 to #n on a plurality of subcarriers forming an OFDM symbol, which is a multicarrier signal, and transmits the signal. Further, base station 100 can be used in a radio communication system where plurality of subcarriers are grouped into a plurality of RBs.

In base station 100, modulating sections 101-1 to 101-n modulate data for a maximum of n terminals #1 to #n, respectively, to generate data symbols, and outputs the data symbols to allocating section 102.

Allocating section 102 allocates the data symbol for each terminal to subcarriers of one of the RBs, and outputs it to multiplexing section 104. Moreover, allocating section 102 outputs DRB specifying information designating which RBs are used as DRBs, as report information for terminals subject to DRB allocation, to control channel signal generating section 103. The RB allocating process in allocating section 102 will be described later in detail.

Control channel signal generating section 103 generates a control channel signal formed with RB information, and outputs the control channel signal to multiplexing section 104.

Multiplexing section 104 multiplexes the control channel signal on the data symbols, and output the multiplexed signal to IFFT (Inverse Fast Fourier Transform) section 105. The multiplexing of a control channel signal may employ either frequency division multiplexing or time division multiplexing.

IFFT section 105 performs an IFFT on a plurality of subcarriers to which the data symbols or the control channel signal are allocated, to generate an OFDM symbol, which is a multicarrier signal. By this means, the data symbols for terminals #1 to #n are frequency division multiplexed on a plurality of subcarriers forming an OFDM symbol. This OFDM symbol is inputted to CP (Cyclic Prefix) attaching section 106.

CP attaching section 106 attaches the same signal as the tail part of the OFDM symbol to the beginning of that OFDM symbol as a CP.

Radio transmitting section 107 performs transmission processing including D/A conversion, amplification and up-conversion, on the OFDM symbol with an attachment of a CP, and transmits the OFDM symbol from antenna 108 to each terminal. That is, radio transmitting section 107 transmits the OFDM symbol including data for terminals #1 to #n.

On the other hand, radio receiving section 109 receives n OFDM symbols via antenna 108, transmitted at the same time from n terminals #1 to #n, and performs receiving processing including down-conversion and D/A conversion on these OFDM symbols. The OFDM symbols after the receiving processing are inputted to CP removing section 110.

CP removing section 110 removes the CPs from the OFDM symbols after the receiving processing, and outputs the resulting OFDM symbols to FFT (Fast Fourier Transform) section 111.

FFT section 111 performs FFT processing on the OFDM symbol after the CP removal, to acquire frequency division multiplexed, terminal-specific signals. The terminal-specific signals after the FFT are inputted to demodulating sections 112-1 to 112-n.

Here, the terminals transmit signals using unique subcarriers or unique RBs, and the terminal-specific signals include downlink channel quality information for each RB reported from terminals. Besides, each terminal is able to measure the received quality of each RB, from, for example, the received SNR, received SIR, received SINR, received CINR, received power, interference power, bit error rate, throughput, MCS that achieves a predetermined error rate, and so on. In addition, channel quality information may be referred to as “CQI” (Channel Quality Indicator) or “CSI” (Channel State Information), for example.

Demodulating sections 112-1 to 112-n, which are provided so as to correspond to terminals #1 to #n, perform demodulation processing on the signals after FFT, and output channel quality information per RB acquired through the demodulation processing, to allocating section 102.

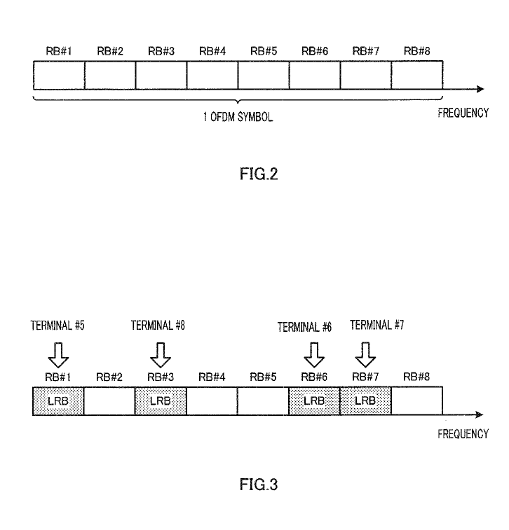

Next, RB allocating process in allocating section 102 will be explained in detail. Here, a plurality of subcarriers forming one OFDM symbol is equally grouped into eight RBs, that is, RBs #1 to #8, as shown in FIG. 2. Further, the number of subcarriers forming one OFDM symbol is ninety six, that is, subcarriers f₁ to f₉₆. Consequently, the RBs each include twelve subcarriers.

Allocating section 102 allocates data for terminals according to the allocation rules shared with the terminals, to the remaining RBs other than the RBs used in priority allocation among RBs #1 to #8. Here, as above, priority allocation to LRBs used in frequency scheduling will be explained as an example of priority allocation.

Further, allocating section 102 receives terminal information as input showing that terminals #1 to #n are subject to LRB allocation (that is, frequency scheduling transmission) or DRB allocation (that is, frequency diversity transmission), and, classifies terminals #1 to #n into terminals subject to LRB allocation and terminals subject to DRB allocation. The terminal information is transmitted to the terminals as a control channel signal in advance. Here, a case will be assumed that DRB allocation is performed for terminals #1 to #4 and LRB allocation is performed for terminals #5 to #8.

That is, allocating section 102 performs LRB allocation of data for terminals #5 to #8 prior to the DRB allocation of data for terminals #1 to #4. After having allocated data, with priority, for terminals #5 to #8 to any of RBs #1 to #8 by frequency scheduling according to channel quality per terminal or RB, allocating section 102 uses, as DRBs, the remaining RBs other than the RBs used in priority allocation for terminals #5 to #8, and allocates data for terminal #1 to #4 according to the allocation rules shared with the terminals, to the remaining RBs. More specifically, RBs are allocated as follows.

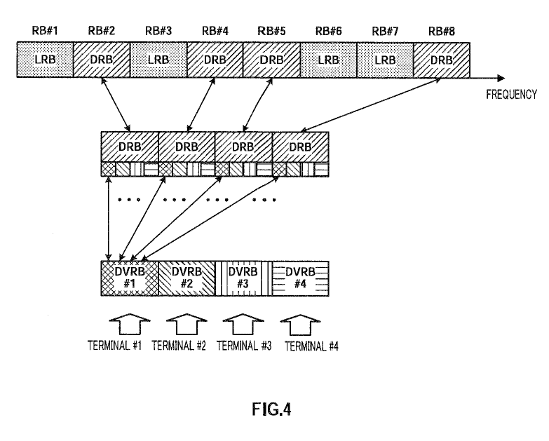

First, targeting all of RBs #1 to #8, allocating section 102 performs LRB allocation for terminals #5 to #8 by frequency scheduling. Here, in RBs #1 to #8, assume that the channel quality of terminal #5 is the highest in RB #1, the channel quality of terminal #6 is the highest in RB #6, the channel quality of terminal #7 is the highest in RB #7, and the channel quality of terminal #8 is the highest in RB #3. That is, as a result of this LRB allocation, as shown in FIG. 3, the data for terminal #5 is allocated to subcarriers f₁ to f₁₂ in RB #1, the data for terminal #8 is allocated to subcarriers f₂₅ to f₃₆ in RB #3, the data for terminal #6 is allocated to subcarriers f₆₁ to f₇₂ in RB #6, and the data for terminal #7 is allocated to subcarriers f₇₃ to f₈₄ in RB #7.

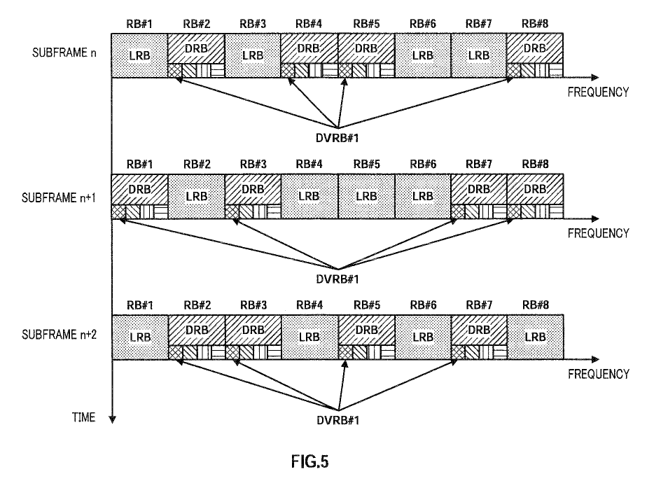

Next, as shown in FIG. 4, allocating section 102 concatenates RBs #2, #4, #5 and #8 of the remaining RBs other than RBs #1, #3, #6 and #7 where the data for terminals #5 to #8 is allocated, to use them as DRBs, and performs DRB allocation for terminals #1 to #4 according to the allocation rules shared with the terminals. Examples of allocation rules for use in DRB allocation will be shown below.

The following allocation rule example 1 defines four allocation rules as DVRBs (Distributed Virtual Resource Blocks) #1 to #4. Further, N_{DRB} is the number of DRBs in one subframe and N_{subcarrier} is the number of subcarriers in one DRB. Accordingly, here, N_{DRB} is four and N_{subcarrier} is twelve. Then, DVRBs #1 to #4 each show the subcarrier number “1” after the concatenation of all DRBs. Accordingly, for example, DVRB #1 shows the first, second, third, thirteenth, fourteenth, fifteenth, twenty-fifth, twenty-sixth, twenty-seventh, thirty-seventh, thirty-eighth, and thirty-ninth subcarriers in forty eight subcarriers after concatenation of four DRBs, and these subcarriers correspond to subcarriers f₁₃, f₁₄, f₁₅, f₃₇, f₃₈, f₃₉, f₄₉, f₅₀, f₅₁, f₈₅, f₈₆, and f₈₇ in the remaining RBs #2, #4, #5, and #8. The same applies to DVRBs #2 to #4. In this way, the present embodiment uses, as an allocation rule in distributed allocation, a rule of defining the allocation positions of subcarriers in the remaining RBs to allocate data for terminals.

$$\begin{matrix}[ 1 ] & \\ < Allocation rule example 1 > & \\ \{ \begin{matrix}\begin{matrix}DVRB \#1 \text{:} {l}_{mn , 1} = m + ( n - 1 ) \times {N}_{subcarrier} \\ = m + ( n - 1 ) \times 12 \\ = 1 , 2 , 3 , 13 , 14 , 15 , 25 , 26 , 27 , 37 , 38 , 39\end{matrix} \\ \begin{matrix}DVRB \#2 \text{:} {l}_{mn , 2} = m + \frac{{N}_{subcarrier}}{{N}_{DRB}} \times 1 + ( n - 1 ) \times {N}_{subcarrier} \\ = m + 3 + ( n - 1 ) \times 12 \\ = 4 , 5 , 6 , 16 , 17 , 18 , 28 , 29 , 30 , 40 , 41 , 42\end{matrix} \\ \begin{matrix}DVRB \#3 \text{:} {l}_{mn , 3} = m + \frac{{N}_{subcarrier}}{{N}_{DRB}} \times 2 + ( n - 1 ) \times {N}_{subcarrier} \\ = m + 6 + ( n - 1 ) \times 12 \\ = 7 , 8 , 9 , 19 , 20 , 21 , 31 , 32 , 33 , 43 , 44 , 45\end{matrix} \\ \begin{matrix}DVRB \#4 \text{:} {l}_{mn , 4} = m + \frac{{N}_{subcarrier}}{{N}_{DRB}} \times 3 + ( n - 1 ) \times {N}_{subcarrier} \\ = m + 9 + ( n - 1 ) \times 12 \\ = 10 , 11 , 12 , 22 , 23 , 24 , 34 , 35 , 36 , 46 , 47 , 48\end{matrix}\end{matrix} & ( Equation 1 ) \\ where m = 1 , 2 , … \frac{{N}_{subcarrier} = 12}{{N}_{DRB} = 4} , n = 1 , 2 , … {N}_{DRB} & \end{matrix}$$

Then, here, as shown in FIG. 4, allocating section 102 uses DVRB #1 for data for terminal #1, DVRB #2 for data for terminal #2, DVRB #3 for data for terminal #3, and DVRB #4 for data for terminal #4. Accordingly, allocating section 102 allocates data for terminal #1 to subcarriers f₁₃, f₁₄, f₁₅, f₃₇, f₃₈, f₃₉, f₄₉, f₅₀, f₅₁, f₈₅, f₈₆, and f₈₇, allocates data for terminal #2 to subcarriers f₁₆, f₁₇, f₁₈, f₄₀, f₄₁, f₄₂, f₅₂, f₅₃, f₅₄, f₈₈, f₈₉, and f₉₀, allocates data for terminal #3 to subcarriers f₁₉, f₂₀, f₂₁, f₄₃, f₄₄, f₄₅, f₅₅, f₅₆, f₅₇, f₉₁, f₉₂, and f₉₃ and allocates data for terminal #4 to subcarriers f₂₂, f₂₃, f₂₄ f₄₆, f₄₇, f₄₈, f₅₈, f₅₉, f₆₀, f₉₄, f₉₅, and f₉₆.

Then, allocating section 102 outputs the terminal ID numbers, DVRB numbers and DRB specifying information to control channel signal generating section 103, and control channel signal generating section 103 generates a control channel signal formed with these information. This control channel signal is transmitted and reported from base station 100 to terminals #1 to #4. The example shown in FIG. 4 shows the DRB specifying information in associated with RBs #1 to #8 and is made “01011001,” where the RBs designated by 1's are used as DRBs. That is, DRB specifying information “01011001” shows that RBs #2, #4, #5 and #8 are used as DRBs and that N_{DRB} is four. The allocation rules of N_{subcarrier} and DVRBs #1 to #4 are known to the terminals, so that each terminal #1 to #4 receiving this control channel is able to identify to which subcarriers of which RBs the data for the terminal is allocated. For example, terminal #1, having received the control channel signal formed with the terminal ID number=#1, the DVRB number=#1 and the DRB specifying information “01011001,” is able to identify that the data for the terminal is distributed-allocated to subcarriers f₁₃, f₁₄ and f₁₅ of RB #2, subcarriers f₃₇, f₃₈ and f₃₉ of RB #4, subcarriers f₄₉, f₅₀ and f₅₁ of RB #5, subcarriers f₈₅, f₈₆ and f₈₇ of RB #8, according to the allocation rule of DVRB #1.

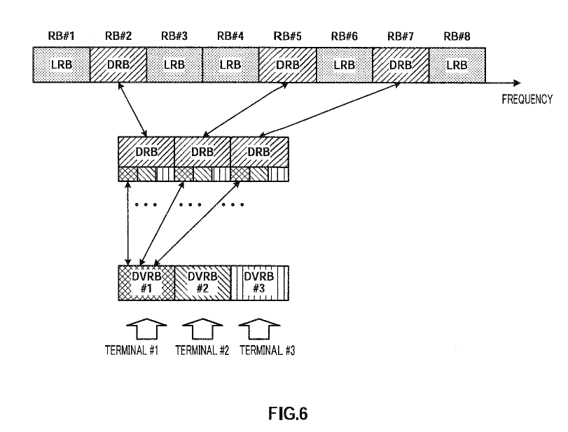

As described above, allocating section 102 performs distributed allocation in the subframes. FIG. 5 shows an example of distributed allocation in subframes n to n+2.

Here, as described above, the allocation rules specified by DVRBs #1 to #4 define the allocation positions of subcarriers in the remaining RBs to allocate data for terminals, so that each terminal is able to identify the subcarriers to which data for the terminal is allocated using the same allocation rule, if the remaining RBs change every subframe depending on priority allocation results. Accordingly, allocating section 102 can use the same allocation rule for the same terminal over a plurality of subframes.

For example, as shown in FIG. 5, if the remaining RBs change as RBs #2, #4, #5 and #8 in subframe n, as RBs #1, #3, #7 and #8 in subframe n+1 and as RBs #2, #3, #5 and #7 in subframe n+2, the terminal is able to identify the subcarriers to which data for the terminal is allocated using the same allocation rule. For example, terminal #1 for which DVRB #1 is used in subframes n+1 and n+2 in addition to subframe n, can identify the subcarriers to which data for the terminal is allocated only if the DRB specifying information is reported, without being reported the DVRB number. That is, in subframe #n, terminal #1 is reported the DVRB number=#1 and DRB specifying information=“01011001,” identifies, in subframe n, that the data for the terminal is distributed-allocated to subcarriers f₁₃, f₁₄ and f₁₅ of RB #2, subcarriers f₃₇, f₃₈ and f₃₉ of RB #4, subcarriers f₄₉, f₅₀ and f₅₁ of RB #5, and, subcarriers f₈₅, f₈₆ and f₈₇ of RB #8. In subframe n+1, terminal #1 is reported DRB specifying information=“10100011” from base station 100 and thereupon identifies, using DVRB number=#1 reported earlier in subframe n, that the data for the terminal is distributed-allocated to subcarriers f₁, f₂ and f₃ of RB #1, subcarriers f₂₅, f₂₆ and f₂₇ of RB #3, subcarriers f₇₃, f₇₄ and f₇₅ of RB #7 and subcarriers f₈₅, f₈₆ and f₈₇ of RB #8. Furthermore, in subframe n+2, terminal #1 is reported DRB specifying information=“011010” from base station 100 and thereupon identifies, using the DVRB number=#1 reported earlier in subframe n, that the data for the terminal is distributed-allocated to subcarriers f₁₃, f₁₄ and f₁₅ of RB #2, subcarriers f₂₅, f₂₆ and f₂₇ of RB #3, subcarriers f₄₉, f₅₀ and f₅₁ of RB #5 and subcarriers f₇₃, f₇₄ and f₇₅ of RB #7.

That is, to a terminal to which the same allocation rule is applied over a plurality of subframes, that is, to a terminal to which TTI concatenation is applied, base station 100 has to report the terminal ID number and DVRB number only in the first subframe among a plurality of subframes and therefore does not report the terminal ID number and DVRB number in the following subframes other than the first subframe among a plurality of subframes. That is, to a terminal to which the same allocation rule is applied over a plurality of subframes, control channel signal generating section 103 generates a control channel signal formed with the terminal ID number, DVRB number and DRB specifying information only in the first subframe among a plurality of subframes, and generates a control channel signal formed with DRB specifying information in the following subframes other than the first subframe in a plurality of subframes.

In this way, according to the present embodiment, if a change of LRBs every subframe depending on priority allocation results leads to a change of DRBs every subframe, the same DVRB is applied to the same terminal over a plurality of subframes, so that it is possible to enable prioritized allocation of RBs and perform distributed allocation with a reduced amount of control information. Consequently, the present embodiment makes it possible to prioritize the allocation of RBs and apply TTI concatenation to distributed allocation.

If a change of the number of LRBs subject to priority allocation results in a change of the number of remaining RBs, to keep the size of RBs per terminal used in distributed allocation, it is preferable to change the allocation rule as appropriate depending on the number of remaining RBs.

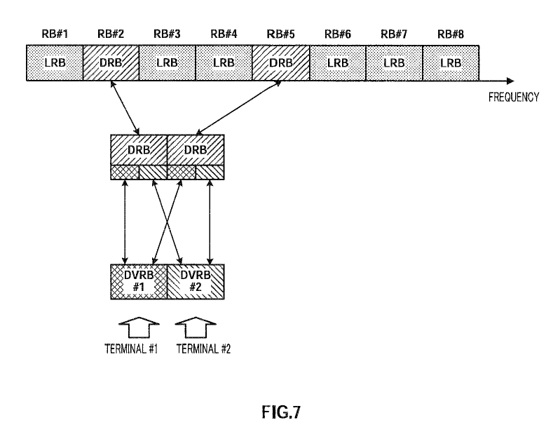

For example, as shown in FIG. 6, in RBs #1 to #8, when the remaining RBs used as DRB is three (that is, when N_{DRB}=3), the allocation rule shown in the following allocation rule example 2 may be used.

### <Allocation Rule Example 2>

$$\begin{matrix}\{ \begin{matrix}\begin{matrix}DVRB \#1 \text{:} {l}_{mn , 1} = m + ( n - 1 ) \times {N}_{subcarrier} \\ = m + ( n - 1 ) \times 12 \\ = 1 , 2 , 3 , 4 , 13 , 14 , 15 , 16 , 25 , 26 , 27 , 28\end{matrix} \\ \begin{matrix}DVRB \#2 \text{:} {l}_{mn , 2} = m + \frac{{N}_{subcarrier}}{{N}_{DRB}} \times 1 + ( n - 1 ) \times {N}_{subcarrier} \\ = m + 4 + ( n - 1 ) \times 12 \\ = 5 , 6 , 7 , 8 , 17 , 18 , 19 , 20 , 29 , 30 , 31 , 32\end{matrix} \\ \begin{matrix}DVRB \#3 \text{:} {l}_{mn , 3} = m + \frac{{N}_{subcarrier}}{{N}_{DRB}} \times 2 + ( n - 1 ) \times {N}_{subcarrier} \\ = m + 8 + ( n - 1 ) \times 12 \\ = 9 , 10 , 11 , 12 , 21 , 22 , 23 , 24 , 33 , 34 , 35 , 36\end{matrix}\end{matrix} & ( Equation 2 ) \\ where m = 1 , 2 , … \frac{{N}_{subcarrier} = 12}{{N}_{DRB} = 3} , n = 1 , 2 , … {N}_{DRB} = 3 & \end{matrix}$$

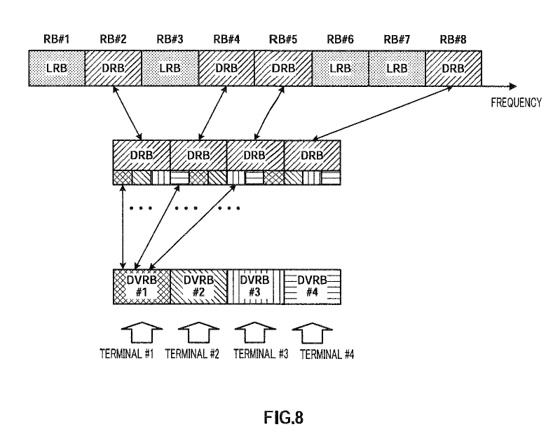

For example, as shown in FIG. 7, in RBs #1 to #8, when the remaining RBs used as DRBs is two (that is, when N_{DRB}=2), the allocation rule shown in the following allocation rule example 3 may be used.

### <Allocation Rule Example 3>

$$\begin{matrix}\{ \begin{matrix}\begin{matrix}DVRB \#1 \text{:} {l}_{mn , 1} = m + ( n - 1 ) \times {N}_{subcarrier} \\ = m + ( n - 1 ) \times 12 \\ = 1 , 2 , 3 , 4 , 5 , 6 , 13 , 14 , 15 , 16 , 17 , 18\end{matrix} \\ \begin{matrix}DVRB \#2 \text{:} {l}_{mn , 2} = m + \frac{{N}_{subcarrier}}{{N}_{DRB}} \times 1 + ( n - 1 ) \times {N}_{subcarrier} \\ = m + 6 + ( n - 1 ) \times 12 \\ = 7 , 8 , 9 , 10 , 11 , 12 , 19 , 20 , 21 , 22 , 23 , 24\end{matrix}\end{matrix} & ( Equation 3 ) \\ where m = 1 , 2 , … \frac{{N}_{subcarrier} = 12}{{N}_{DRB} = 2} , n = 1 , 2 , … {N}_{DRB} = 2 & \end{matrix}$$

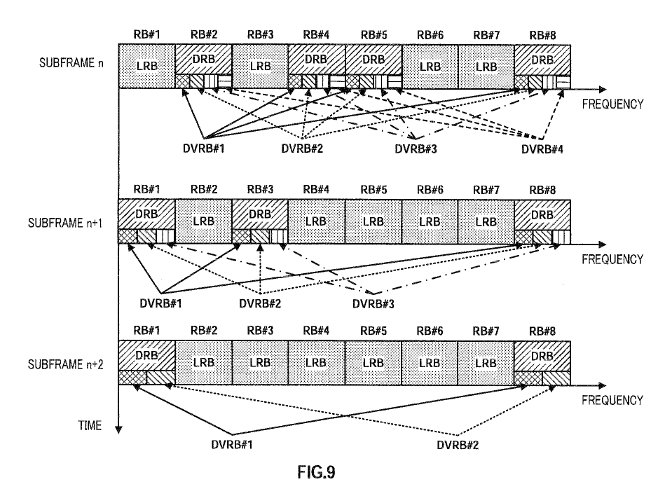

Further, for example, as shown in FIG. 8, the allocation rule shown in the following allocation rule example 4 may be used instead of the allocation rule shown in above allocation rule example 1. In allocation rule example 4, N_{seg} is the number of subcarriers in one segment when one DRB is equally divided into a plurality of segments, and, N_{seg} is four here because one DRB is equally divided into three segments.

### <Allocation Rule Example 4>

$$\begin{matrix}\{ \begin{matrix}\begin{matrix}DVRB \#1 \text{:} {l}_{mn , 1} = m + ( n - 1 ) \times {N}_{seg} \times {N}_{DRB} \\ = m + ( n - 1 ) \times 16 \\ = 1 , 2 , 3 , 4 , 17 , 18 , 19 , 20 , 33 , 34 , 35 , 36\end{matrix} \\ \begin{matrix}DVRB \#2 \text{:} {l}_{mn , 2} = m + {N}_{seg} \times 1 + ( n - 1 ) \times {N}_{seg} \times {N}_{DRB} \\ = m + 4 + ( n - 1 ) \times 16 \\ = 5 , 6 , 7 , 8 , 21 , 22 , 23 , 24 , 37 , 38 , 39 , 40\end{matrix} \\ \begin{matrix}DVRB \#3 \text{:} {l}_{mn , 3} = m + {N}_{seg} \times 2 + ( n - 1 ) \times {N}_{seg} \times {N}_{DRB} \\ = m + 8 + ( n - 1 ) \times 16 \\ = 9 , 10 , 11 , 12 , 25 , 26 , 27 , 28 , 41 , 42 , 43 , 44\end{matrix} \\ \begin{matrix}DVRB \#4 \text{:} {l}_{mn , 4} = m + {N}_{seg} \times 3 + ( n - 1 ) \times {N}_{seg} \times {N}_{DRB} \\ = m + 12 + ( n - 1 ) \times 16 \\ = 13 , 14 , 15 , 16 , 29 , 30 , 31 , 32 , 45 , 46 , 47 , 48\end{matrix}\end{matrix} & ( Equation 4 ) \\ where m = 1 , 2 , … {N}_{seg} , n = 1 , 2 , … \frac{{N}_{subcarrier}}{{N}_{seg}} = 2 & \end{matrix}$$

### Embodiment 2

As shown in FIG. 9, by making greater the number of LRBs to allocate with priority as time passes, the number of RBs available for use as DRBs may decrease. At this time, as shown in the above, if a change of the number of LRBs subject to priority allocation results in a change of the number of remaining RBs, to keep the size of RBs used in distributed allocation per terminal constantly, it is preferable to change the allocation rules as appropriate depending on the number of remaining RBs. That is, in the example shown in FIG. 9, all DVRBs #1 to #4 can be used in subframe n, but only DVRBs #1 to #3 can be used in subframe n+1, and only DVRBs #1 and #2 can be used in subframe n+2.

In such a case, if DVRB #3 or DVRB #4 is used in subframe n for a terminal to which the same allocation rule is applied over a plurality of subframes n to n+2, that is, for a terminal to which TTI concatenation is applied, the terminal is unable to identify to which subcarriers the data for the terminal is distributed-allocated, in subframes n+2 if DVRB #3 is used and in both subframes n+1 and n+2 if DVRB #4 is used.

Then, in the present embodiment, the order of a plurality of allocation rules (i.e. DVRBs #1 to #4) that differ in the allocation positions of subcarriers to allocate data for each terminal in the remaining RBs, is determined in advance, and, following this order, a terminal uses the earliest one among the allocation rules not used for other terminals.

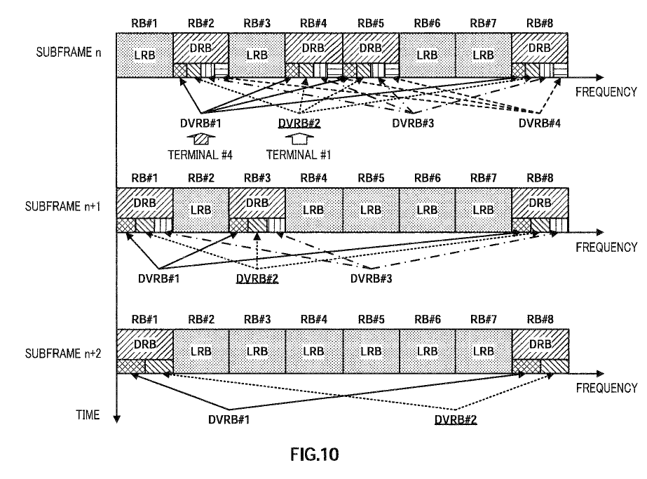

To be more specific, the order of DVRBs #1 to #4 is determined in advance such that DVRB #1 is the first, DVRB #2 is the second, DVRB #3 is the third and DVRB #4 is the fourth. Then, for example, as shown in FIG. 10, when, in subframe n, DVRB #1 is already used for terminal #4 among DVRBs #1 to #4 and the allocation rules not yet in use are DVRBs #2 to #4, allocating section 102 uses DVRB #2 of the earliest order among DVRBs #2 to #4, for terminal #1, to which the same allocation rule is applied over subframes n to n+2. As an example of FIG. 10, DVRB #2 can continue being used in subframes n+1 and n+2, so that terminal #1 can identify to which subcarriers data for the terminal is distributed-allocated in both subframes n+1 and n+2.

In this way, according to the present embodiment, allocation rules are used in order from the earliest order among the allocation rules not in use, so that it is possible to minimize the likelihood of making a terminal, to which the same allocation rule is applied over a plurality of subframes, that is, a terminal to which TTI concatenation is applied, unable to identify to which subcarriers data for the terminal is distributed-allocated.

### Embodiment 3

The present embodiment copes with the unfavorable scene explained at the beginning of Embodiment 2, by shifting allocation rules to allocation rules of earlier orders over time.

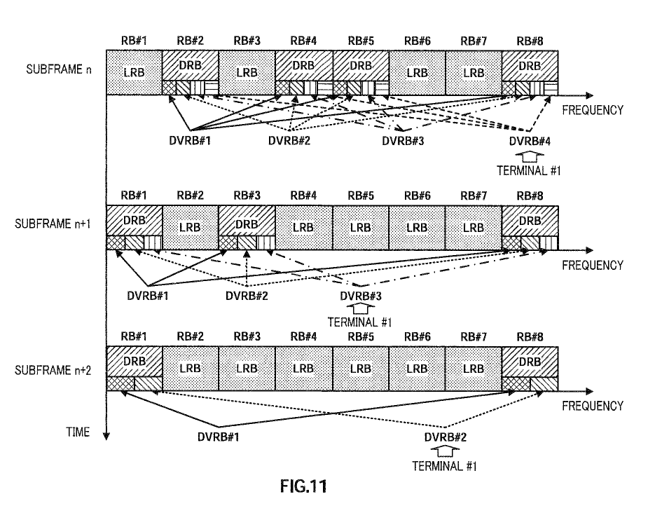

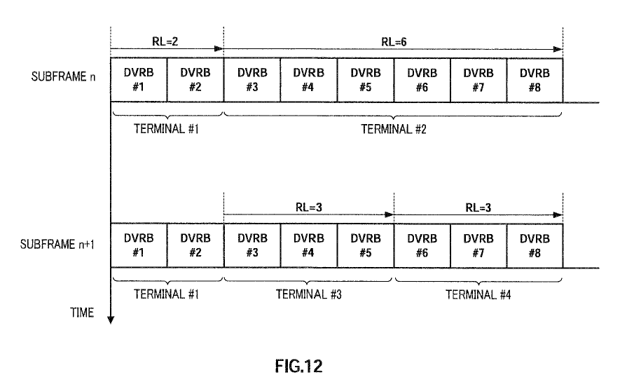

To be more specific, as in Embodiment 2, the order of DVRBs #1 to #4 is determined in advance such that DVRB #1 is the first, DVRB #2 is the second, DVRB #3 is the third and DVRB #4 is the fourth. Then, for example, as shown in FIG. 11, when, in subframe n, DVRBs #1 to #3 among DVRBs #1 to #4 are already used for other terminals and DVRB #4 is the only allocation rule not yet in use, allocating section 102 uses DVRB #4 for terminal #1. Next, in subframe n+1, allocating section 102 shifts the DVRB for use for terminal #1 from DVRB #4 to DVRB #3. Further, in subframe n+2, allocating section 102 shifts the DVRB for use for terminal #1 from DVRB #3 to DVRB #2. In the example of FIG. 11, DVRB #3 can also be used in subframe n+1, and DVRB #2 can also be used in subframe n+2, so that terminal #1 is able to identify to which subcarriers data for the terminal is distributed-allocated in all of subframes n to n+2.

In this way, according to the present embodiment, allocation rules are shifted to allocation rules of earlier orders over time, and so it is not possible to apply TTI concatenation to distributed allocation. However, it is possible to reduce the likelihood of making a terminal subject to distributed allocation unable to identify to which subcarriers data for the terminal is distributed-allocated.

Furthermore, in cases where a plurality of terminals are classified into terminals of the higher priorities and terminals of the lower priorities, it is particularly effective to apply the present embodiment to the terminals of the higher priorities.

Further, although a case has been shown with the present embodiment where the DVRB number decreases one every time one subframe passes, it is equally possible to decrease the DVRB number by one every time plurality of subframes pass, and decrease the DVRB number by two or more every time one subframe passes. Further, the range of decrease of the DVRB number may be made greater when the number of DRBs per subframe increases. Further, when the DVRB number gradually decreases over time and reaches the minimum value #1, in the following subframes, DVRB #1 may continue being used.

### Embodiment 4

To reduce the overhead of control channel signals, the base station reports the DVRB number to the terminal using the run-length (RL) method, which is one of information compression methods.

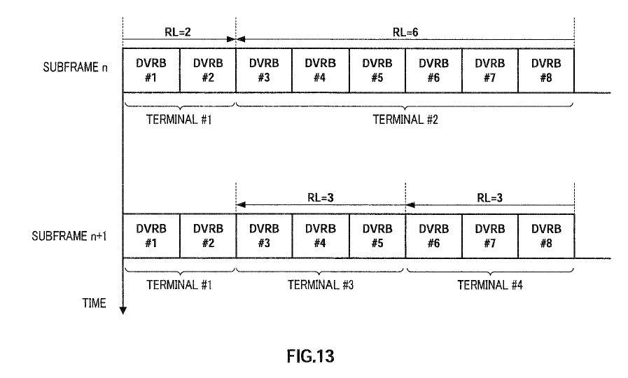

To be more specific, in subframe n, if DVRBs #1 and #2 are allocated to terminal #1 and DVRBs #3 to #8 are allocated to terminal #2 among DVRBs #1 to #8 as shown in FIG. 12, as RL information starting from DVRB #1, it is possible to report RL=2 for terminal #1 and RL=6 for terminal #2.

Here, if terminal #1 is applied the same allocation rule over a plurality of subframes, that is, if terminal #1 is applied TTI concatenation, in subframe n+1, the base station 100 does not report RL information for terminal #1. That is, terminal #3, newly allocated DVRBs #3 to #5 and reported RL=3, and terminal #4, newly allocated DVRBs #6 to #8 and reported RL=3, do not have RL information for terminal #1, so that the RL starting point moves and terminals #3 and #4 misidentify the DVRBs allocated to the terminals. Here, terminals #2 to #4 are applied different DVRBs between subframes and are therefore not applied TTI concatenation.

Then, according to the present embodiment, the order of a plurality of allocation rules (here, DVRBs #1 to #8) that differ in the allocation positions of subcarriers to allocate data in the remaining RBs, is determined in advance, and, following this order, a terminal to which the same allocation rule is applied over a plurality of subframes, that is, a terminal to which TTI concatenation is applied, uses the allocation rules not in use for other terminals in order from the earliest order, and, on the other hand, a terminal to which different allocation rules are applied on a per subframe basis, that is, a terminal to which TTI concatenation is not applied, follows the same order and uses the allocation rules not in use for other terminals in order from the latest order.

To be more specific, the order of DVRBs #1 to #8 is determined in advance such that DVRB #1 is the first, DVRB #2 is the second, DVRB #3 is the third, DVRB #4 is the fourth, DVRB #5 is the fifth, DVRB #6 is the sixth, DVRB #7 is the seventh, and DVRB #8 is the eighth.

Then, as shown in FIG. 13, in subframe n, allocating section 102 allocates DVRBs #1 and #2 to terminal #1 in order from the earliest order and allocates DVRBs #8 to #3 to terminal #2 in order from the latest order, and outputs the allocation results to control channel signal generating section 103. Control channel signal generating section 103 generates a control channel signal formed with RL information (RL=2) starting from DVRB #1 as a control channel signal for terminal #1, and generates a control channel signal formed with RL information (RL=6) starting from DVRB #8 as a control channel signal for terminal #2.

Further, in subframe n+1 where base station 100 does not report the RL information for terminal #1, as shown in FIG. 13, allocating section 102 allocates DVRBs #8 to #6 to terminal #4 and DVRBs #5 to #3 to terminal #3 in order from the latest order and outputs the allocation result to control channel signal generating section 103. Then, control channel signal generating section 103 generates a control channel signal formed with RL information (RL=3) starting from DVRB #8 as a control channel signal for terminal #4, and a control channel signal formed with RL information (RL=3) as a control channel signal for terminal #3.

Although an example has been shown in FIG. 13 where the allocation rules are used in ascending order for a terminal to which the same allocation rule is applied over a plurality of subframes and where the allocation rules are used in descending order for a terminal to which different allocation rules are applied on a per subframe basis, these ascending order and descending order may be applied reverse. That is, the allocation rules may be used in descending order for a terminal to which the same allocation rule is applied over a plurality of subframes and likewise the allocation rules may be used in ascending order for a terminal to which different allocation rules are applied on a per subframe basis.

In this way, according to the present embodiment, when the DVRB numbers are reported to terminals using the RL method, the allocation rules are used in opposite orders between a terminal to which the same allocation rule is applied over a plurality of subframes, that is, a terminal to which TTI concatenation is applied, and a terminal to which different allocation rules are applied on a per subframe basis, that is, a terminal to which TTI concatenation is not applied, so that it is possible to prevent a terminal to which different allocation rules are applied on a per subframe basis from misidentifying the DVRBs allocated to the terminal.

Although an embodiment has been described above where the DVRB numbers are reported to terminals using the RL method, the information compressing method applicable to the present invention is not limited to the RL method. As long as the method is capable of compressing and reporting consecutive DVRB numbers, any information compression method may be used to implement the present invention.

Embodiments of the present invention have been explained.

The DFT (Discrete Fourier Transform) and IDFT (Inverse Discrete Fourier Transform) may be used instead of the FFT and IFFT in the embodiments. Further, the time-frequency domain transform method and the frequency-time domain transform method are not limited to the FFT, DFT, IFFT and IDFT.

An RB may be referred to as a “sub-band,” “sub-channel,” “subcarrier block,” or “chunk.” A CP may be referred to as a “guard interval (GI).” A subcarrier may be referred to as a “tone.” A base station and terminal may be referred to as a “Node B” and “mobile station,” “UE,” respectively.

Moreover, although cases have been described with the embodiments above where the present invention is configured by hardware, the present invention may be implemented by software.

Each function block employed in the description of the aforementioned embodiment may typically be implemented as an LSI constituted by an integrated circuit. These may be individual chips or partially or totally contained on a single chip. “LSI” is adopted here but this may also be referred to as “IC,” “system LSI,” “super LSI” or “ultra LSI” depending on differing extents of integration.

Further, the method of circuit integration is not limited to LSI's, and implementation using dedicated circuitry or general purpose processors is also possible. After LSI manufacture, utilization of an FPGA (Field Programmable Gate Array) or a reconfigurable processor where connections and settings of circuit cells within an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosure of Japanese Patent Application No. 2006-175820, filed on Jun. 26, 2006, including the specification, drawings and abstract, is incorporated herein by reference in its entirety.

### INDUSTRIAL APPLICABILITY

The present invention is applicable to, for example, mobile communication systems.

1-7. (canceled)

8. A radio communication base station apparatus used in a radio communication system in which a plurality of subcarriers for transmitting a multicarrier signal are grouped into a plurality of resource blocks, the apparatus comprising:
an allocating section that, in the plurality of resource blocks, allocates data for a radio communication terminal to remaining resource blocks other than resource blocks used in a priority allocation according to an allocation rule; and
a transmitting section that transmits the multicarrier signal including the data.

9. The radio communication base station apparatus according to claim 8, wherein the allocating section performs a distributed allocation of the data according to an allocation rule shared with the radio communication terminal.

10. The radio communication base station apparatus according to claim 8, wherein:
the allocation rule defines allocation positions of subcarriers to allocate data in remaining resource blocks; and
the allocating section performs a distributed allocation of the data to the remaining resource blocks according to the allocation positions.

11. The radio communication base station apparatus according to claim 10, wherein:
an order of the plurality of allocation rules that differ in allocation positions is determined in advance; and
with respect to a radio communication terminal to which the same allocation rule is applied over a plurality of subframes, following the order, the allocating section uses allocation rules in order from an earliest order among the allocation rules not in use for other radio communication terminals.

12. The radio communication base station apparatus according to claim 10, wherein:
an order of the plurality of allocation rules that differ in the allocation positions is determined in advance; and
the allocating section shifts the allocation rules in order to an earlier order over time.

13. The radio communication base station apparatus according to claim 10, wherein:
an order of the plurality of allocation rules that differ in allocation positions is determined in advance; and
following the order, the allocating section uses:
with respect to radio communication terminal to which the same allocation rule is applied over a plurality of subframes, allocation rules in order from an earliest order among the allocation rules not in use for other radio communication terminals; and
with respect to the radio communication terminal to which different allocation rules are applied on a per subframe basis, allocation rules in order from a latest order among the allocation rules not in use for other radio communication terminals.

14. The radio communication base station apparatus according to claim 10, wherein:
an order of the plurality of allocation rules that differ in allocation positions is determined in advance; and
following the order, the allocating section uses:
with respect to radio communication terminal to which the same allocation rule is applied over a plurality of subframes, allocation rules in order from a latest order among the allocation rules not in use for other radio communication terminals; and
with respect to the radio communication terminal to which different allocation rules are applied on a per subframe basis, allocation rules in order from an earliest order among the allocation rules not in use for other radio communication terminals.

15. A resource allocation method used in a radio communication system in which a plurality of subcarriers for transmitting a multicarrier signal are grouped into a plurality of resource blocks, the method comprising allocating, in the plurality of resource blocks, data for a radio communication terminal to remaining resource blocks other than resource blocks used in a priority allocation according to an allocation rule.
